(19) United States
(12) Patent Application Publication
(10) Pub. No.: US 2005/0094088 A1
(43) Pub. Date: May 5, 2005

(54) Method for forming liquid crystal display panel

(76) Inventors: Tsung-Yu Yu Kao, Tao-Yuan City (TW); Po-Hsiu Shih, Taipei Hsien (TW)

Correspondence Address: BIRCH STEWART KOLASCH & BIRCH, PO BOX 747, FALLS CHURCH, VA, 22040-0747, US

(21) Appl. No.: 10/698,627

(22) Filed: Nov. 3, 2003

(51) Int. Cl. G02F 1/1339

(52) U.S. Cl. 349/190

(57) ABSTRACT

The present invention provides a method for forming a sealant on the four-side of the bottom substrate during the TFT-LCDs (thin-film transistor liquid crystal display) manufacturing process. The method comprising the starting point droplet of the sealant is first dispensed on the corner of the bottom substrate, and ending on the same corner. Because of the distance between the corner and the liquid crystal on the bottom substrate is larger than the distance between the four-sided and the liquid crystal on the bottom substrate. Thus, after pressing the sealant, the droplet of the sealant would not be spilled to contaminate the TFT-LCDs panel. Therefore, the process window for the liquid crystal display panel manufacturing could be increased.

### BACKGROUND OF THE INVENTION

1. Field of the Invention

The present invention generally relates to a method for forming liquid crystal display panel, and more particularly to a method for forming a sealant on the surface of one of two substrates of liquid crystal display panel by one-drop fill process for liquid crystal display panel manufacturing.

2. Description of the Prior Art

In general, a liquid crystal display panel has the advantages of lightweight, and low power consumption. For that reason, such panels are widely utilized in various types of electronic equipment, from pocket calculators to large-scale office automation equipment. The basic structure of a liquid crystal display panel is shown in FIG. 1. A thin layer of liquid crystal display is retained between two substrates by a sealant. The substrate has transparent electrodes formed on regions of the inner surface thereof, with an orientation layer (i.e. for molecular alignment of the liquid crystal) formed over the electrodes and the remainder of the inner surface of the substrate. The substrate is similarly formed with transparent electrodes and orientation layer. Spacers are disposed in the liquid crystal, for maintaining a uniform size of gap between the two opposing surface of the substrates.

In general, it is necessary to mutually laterally position the two substrates of a liquid crystal display panel to a very high degree of accuracy, i.e. to position one substrate very precisely above the other. The most generally used method of manufacture for such a liquid crystal display panel as follows.

Firstly, an empty cell is formed, i.e. consisting of the two opposed substrate accurately mutually aligned, and mutually attached by the sealant between them, but without the liquid crystal. The empty cell is then filled with the liquid crystal, utilizing a vacuum insertion method. However, such a method has various disadvantages, such as a considerable length of time being required to complete the process of filling the cell with the liquid crystal, in the case of a large-size liquid crystal display panel.

For this reason, a method of manufacture has been proposed which is based upon first dropping liquid crystal onto substrate. The method superior to the vacuum insertion method, since short time is required to fill the space between the two substrates with the liquid crystal. The basic concepts of the one-drop-filling method in which a sealant is formed in a peripheral region of one substrate, while liquid crystal is dropped onto the other substrate. With the two substrates held spaced apart, the substrates are placed within a vacuum chamber of a vacuum assembly apparatus. The lateral positions of the two substrates are mutually aligned, i.e. so that the substrate becomes positioned precisely above the substrate. The air pressure within the vacuum chamber is continuously reduced, and under the condition of low pressure, the two substrates are brought together so that the substrate becomes superposed on the substrate. Thereafter, the sealant is hardened, e.g. by application of suitable radiation.

Referring to FIG. 1, in the conventional techniques, the starting point of sealant is dispensed on the four-sided 102 of the one of two substrates 100. Due to the sealant with larger diameter in the initial point 104 and the ending point 106 (as shown in FIG. 2A), and the droplet size cannot be controlled. In FIG. 2B, after pressing the sealant, the pressed sealant 110 would be spilled, such that the liquid crystal would be contaminated, and the quality of the liquid crystal display panel would be affected.

### SUMMARY OF THE INVENTION

It is an object of this invention to provide a method for forming a sealant to simplify the TFT-LCDs (thin-film transistor-liquid crystal display) manufacturing process.

It is another object of this invention to provide an UV (ultraviolet) hardened sealant to seal two substrates, such that the manufacturing yield can be maintained

It is a further object of this invention is that the droplet of the sealant is starting deposited on the corner of the one of two substrates, and ending is on the same corner to increase process window.

It is still another object of this invention is that the droplet of the sealant is initially deposited on the corner of the one of two substrates, and end deposited is also outside the corner, such that the cross over point diameter of the sealant can be controlled after the top substrate is aligned over the bottom substrate.

According to abovementioned, the present invention provides a method for forming a sealant on the four-side of the bottom substrate during the TFT-LCDs (thin-film transistor liquid crystal display) manufacturing process. The method comprising the start point droplet of the sealant is first dispensed on the corner of one of two substrates, and end on the same corner. Because of the distance between the corner and the liquid crystal on the bottom substrate is larger than the distance between the four-sided and the liquid crystal on the bottom substrate. Thus, the droplet of the sealant would not be spilled to contaminate the TFT-LCDs panel after pressing the sealant. Therefore, the process window for the liquid crystal display panel manufacturing could be increased.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 is a schematic representation showing the sealant that deposited on the four sides of the surface of substrate in accordance with the conventional prior art;

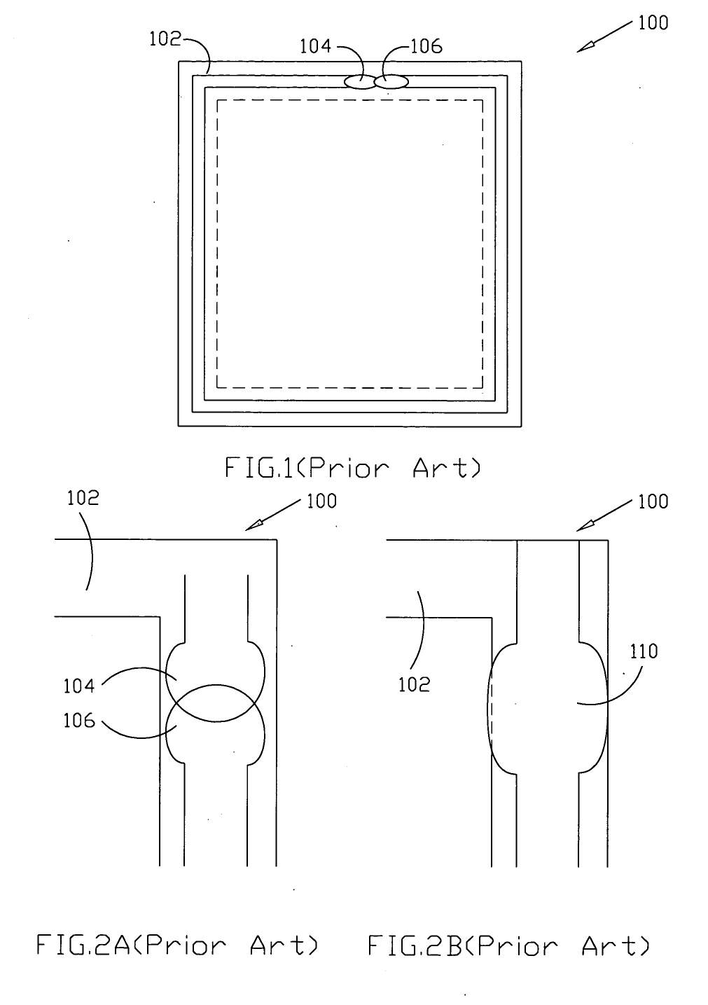

FIG. 2A to FIG. 2B is a schematic representation showing the pressed sealant to spill to the liquid crystal in accordance with the conventional prior art;

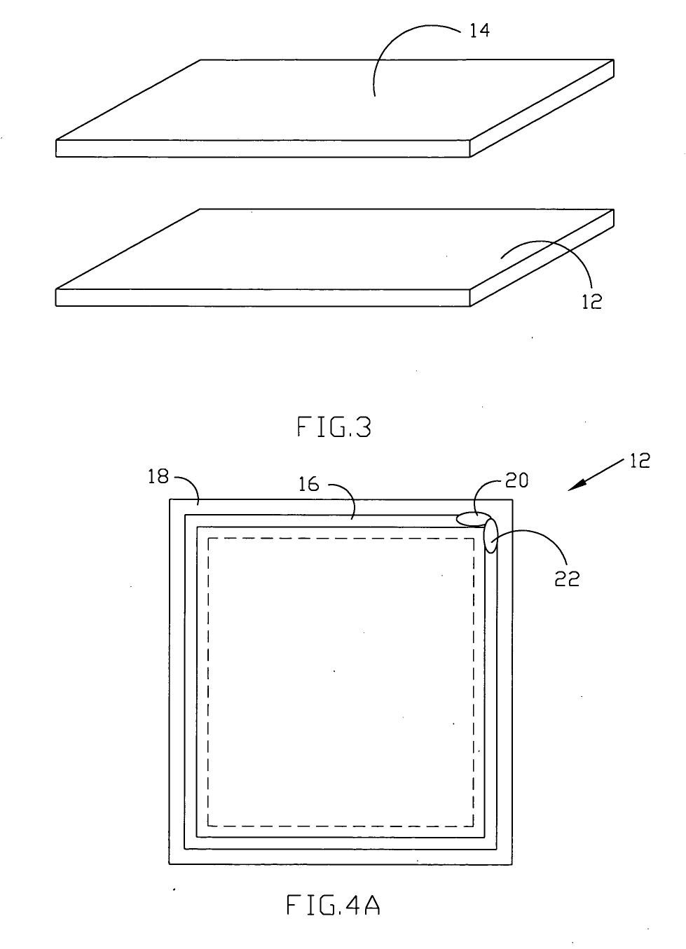

FIG. 3 is a schematic representation showing the pair of the substrates for forming the liquid crystal display panel in accordance with the method disclosed herein;

FIG. 4 is a schematic representation showing the corner of the surface of the substrate used as the connecting position of initial point and the ending point for dispensing the sealant on the surface of one of two substrates in accordance with the method disclosed herein; and

FIG. 5A to FIG. 5C is a schematic representation showing the sealant pressed on the surface of one of two substrates in accordance with the method disclosed herein.

### DESCRIPTION OF THE PREFERRED EMBODIMENT

Some sample embodiments of the invention will now be described in greater detail. Nevertheless, it should be recognized that the present invention can be practiced in a wide range of other embodiments besides those explicitly described, and the scope of the present invention is expressly not limited except as specified in the accompanying claims.

According to the conventional ODF (one-drop fill) process, the sealant is dispensed on the peripheral region of the one of two substrates by using one-drop fill process. Nevertheless, the distance between the peripheral region of the substrate and the liquid crystal on the substrate is short. Thus, when the joint point is constructed from the initial point and the ending point, due to the drop diameter of the initial point and the ending point is larger than other sides on the substrate, such that the excess sealant would be spilled to contaminate the liquid crystal display to affect the quality of the liquid crystal display panel during the spreading the sealant process. Therefore, the present invention provides a one-drop fill process to improve the quality of the liquid crystal display panel.

Furthermore, the advantage of the one-drop fill process is that the liquid crystal insertion process is complexity in the TFT-LCD manufacturing; therefore, the one-drop fill process can simplify the TFT-LCDs manufacturing process. Moreover, the sealant is dispensed around the peripheral region of one of two substrates to form a circle by one-drop fill process. Thus, the injection entrance would not be opened to inject the liquid crystal.

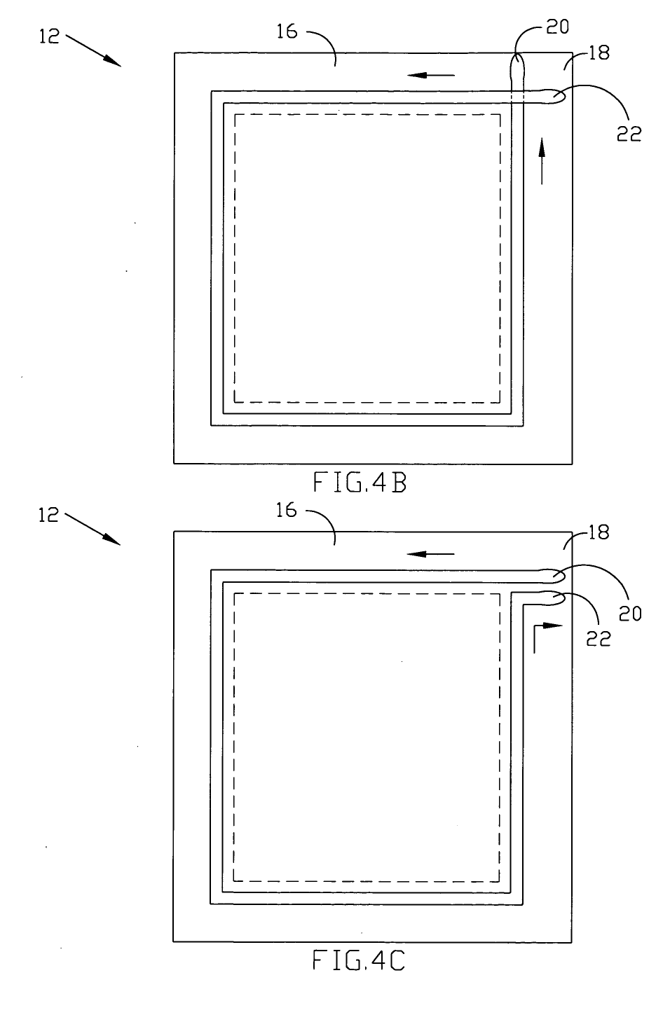

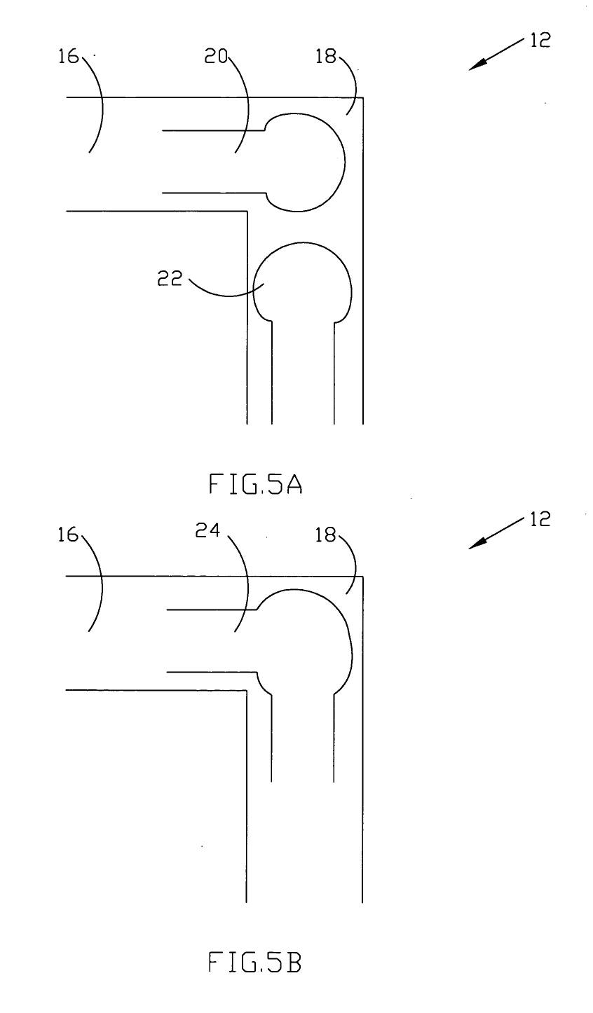

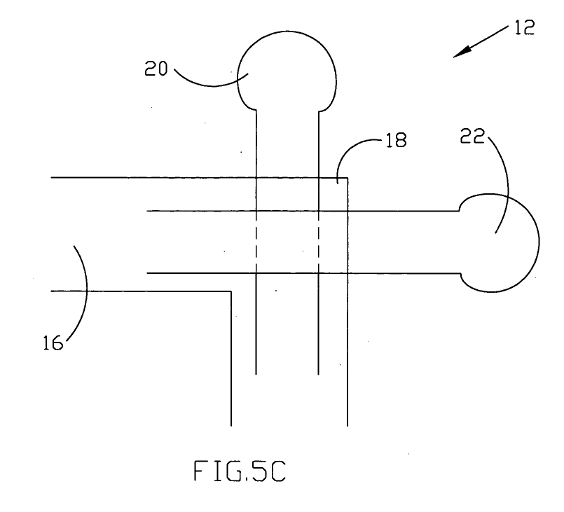

Referring to FIG. 3, reference number 12 and 14 denotes the first substrate and the second substrate, wherein the first substrate 12 is bottom substrate, and the second substrate 14 is top substrate, wherein the top substrate 12 and bottom substrate 14 can be reversed. In the preferred embodiment of the present invention, referring to FIG. 4A, the sealant is dispensed on the four-sided 16 of the bottom substrate 12 by utilizing one-drop fill process. Further, corner 18 of the bottom substrate 12 used as the initial point 20 and the ending point 22(as shown in FIG. 5A), when the sealant is dispensed on the surface of bottom substrate 12, wherein the material of the sealant can be acryl resin or epoxy, and the sealant must be an ultra-violet hardened sealant such that the yield of the TFT-LCDs could be maintained. Furthermore, FIG. 4B and FIG. 4C represent the dispensation method for dispensing the sealant on the four-side of the bottom substrate 12. The initial point 20 and the ending point 22 are the same position on the corner 18 of the bottom substrate 12. Therefore, the initial point 20 and ending point 22 would not contaminate the display region to affect the LCDs quality.

Moreover, the advantage for the initial point 20 and the ending point 22 are the same position on the corner 18 is that the diameter of the initial point 20 and ending point 22 is larger than the diameter of the sealant on the four-sided 16 of the surface of the bottom substrate 12 furthermore, the diameter size of the sealant cannot be controlled to dispense on the surface of the bottom substrate 12when the initial point 20 and the ending point 22 of the droplet of the sealant is dispensed on the corner 18, the distance between the corner 18 and the liquid crystal can be calculated from the Pythagoras' Theorem. For example, the distance between the diameters of the sealant on the four-sided 16 of the surface of the bottom substrate 12 to the liquid crystal is equal to 1, thus, the distance between the diameters of the sealant on the corner 18 to the liquid crystal is about 1.414. Thus, referring to FIG. 5B and FIG. 5C, the distance between the corner 18 of the bottom substrate 12 and the liquid crystal is larger than the distance between the four-sided 16 of the bottom substrate 12, and the liquid crystal. Therefore, the pressed sealant 24 would be contaminate the liquid crystal to affect the quality of the liquid crystal display panel, after pressing the sealant on the bottom substrate 12. Then, the top substrate 14 is superposed over the bottom substrate 12 to form the liquid crystal display panel.

Because of the ultra-violet sealant with high viscosity, the joint point for the initial point 20 and the ending point 22 of the dropped sealant should be dispended on the corner 18 of the surface of the bottom substrate 12 to increase the process window.

Although specific embodiments have been illustrated and described, it will be obvious to those skilled in the art that various modifications may be made without departing from what is intended to be limited solely by the appended claims.

1. A method for forming a liquid crystal display panel, said method comprising the steps of:
providing a bottom substrate with a liquid crystal thereon;
forming a sealant on the peripheral region of said bottom substrate, wherein an initial point and the an ending point locating on the corner of said bottom substrate;
aligning a top substrate to cover on said bottom substrate; and
pressing said top substrate and said bottom substrate.

2. The method according to claim 1, wherein said forming said sealant comprises one-drop fill method.

3. The method according to claim 1, wherein the material of said sealant comprises ultra-violet hardened epoxy resin.

4. The method according to claim 1, wherein the material of said sealant comprises acryl resin.

5. A method for forming a liquid crystal display panel, said method comprising:
providing a bottom substrate with a liquid crystal;
dispensing an initial point of a sealant on a corner of a surface of said bottom substrate and around four-side of said bottom substrate to form a circle on said surface of said bottom substrate, wherein said corner of an ending point and said initial point are the same;;
aligning a top substrate to cover on said bottom substrate; and
pressing said top substrate and said bottom substrate.

6. The method according to claim 5, wherein said dispensing said sealant on said corner of said surface of said bottom substrate as said initial point and around the four-side of outside of liquid crystal to form a circle, wherein said corner of said initial point and said ending point are the same.

7. The method according to claim 5, wherein the material of said sealant comprises ultraviolet hardened epoxy resin.

8. The method according to claim 5, wherein the material of said sealant comprises acryl resin.
